(19) United States
(12) Patent Application Publication
(10) Pub. No.: US 2010/0297858 A1
(43) Pub. Date: Nov. 25, 2010

(54) ELELCTRICAL CONNECTOR WITH NOTCH FOR RECEIVING MATING COMPONENT

(75) Inventor: Cheng-Ching Chien, Tu-Cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION INDUSTRY CO., LTD., Tu-Cheng (TW)

(21) Appl. No.: 12/786,453

(22) Filed: May 25, 2010

(30) Foreign Application Priority Data
May 25, 2009 (TW) 98209138

(51) Int. Cl. H01R 12/14

(52) U.S. Cl. 439/65; 439/83

(57) ABSTRACT

An electrical connector includes an insulative housing and a plurality of contacts. The insulative housing defines a base with opposite front and rear end regions along a front-to-back direction and a plurality of side walls upwardly extending from the base, the base cooperates with the sidewalls to commonly define a first receiving room. A notch defined in the front region of the base forms a second receiving room under the first receiving room, said second receiving room is smaller than the first receiving room. The contacts is disposed in the rear region of said housing with contacting sections extending upwardly beyond an upward mating face of the base and into the first receiving room. An optoelectronic module includes stacked upper portion and lower portion, said upper portion is received in the upper receiving room and said lower portion is received in the lower receiving room. Soldering tails of said contacts are located under the rear region of the base and do not extend into the second receiving room.

### BACKGROUND OF THE INVENTION

1. Field of the Invention

The present invention relates to an electrical connector for receiving card-like components or similar module therein.

2. Description of the Related Art

Conventionally, electrical connectors are widely used in electronic devices to establish electrical connection between two electrical elements. As shown in FIG. 9, an electrical connector is soldered on a circuit board (not shown) by surface mounting technology (SMT). The connector includes a bottom 50 and a cover 60 pivotally mounted on one side of the bottom. The cover has two side walls 600 of L-shaped cross section, extending therefrom for defining a receiving room and a mating component such as card-like member is inserted into the receiving room therefore. The cover loaded with the mating component rotates towards the bottom and then the mating component contacts with the conductive terminals 501 arranged on the bottom. However, a plurality of surface mount tails of the conductive terminals 501 extend into a cutout of the bottom 50, which might come in contact with other electronic thereby an improper electrical connection might be obtained.

In view of the above, a new electrical connector that overcomes the above-mentioned disadvantages is desired.

### SUMMARY OF THE INVENTION

Accordingly, an object of the present invention is to provide an electrical connector assembly which can avoid an improper electrical connection.

To fulfill the above-mentioned object, an electrical connector assembly comprises a printed circuit board defining an upper surface, an insulative housing seated upon the upper surface and a plurality of contacts disposed in the housing. The insulative housing defines a base with opposite front and rear end regions along a front-to-back direction thereof and a plurality of side walls upwardly extending from the base, the base cooperates with the sidewalls to commonly define a first receiving room. A notch defined in the front region of the base forms a second receiving room under the first receiving room, said second receiving room is smaller than the first receiving room in both the front-to-back direction and a transverse direction perpendicular to said front-to-back direction. The contacts is disposed in the rear region of said housing with contacting sections extending upwardly beyond an upward mating face of the base and into the first receiving room. An optoelectronic module includes stacked upper portion and lower portion, said upper portion is received in the upper receiving room and said lower portion is received in the lower receiving room. Soldering tails of said contacts are located under the rear region of the base and do not extend into the second receiving room so as to prevent the soldering tails from being electrically in contact with the lower portion of said optoelectronic module.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of an electrical connector mounted on a circuit board with a cover in an open position in accordance with an embodiment of the present invention;

FIG. 2 is a perspective view of the electrical connector, with the cover removed;

FIG. 3 is a bottom view of the electrical connector;

FIG. 4 is an enlarged perspective view of a portion of the electrical connector shown in FIG. 3;

FIG. 5 is a perspective view of an electrical connector with a cover being in an open position in accordance with a second embodiment of the present invention;

FIG. 6 is a perspective view of the electrical connector, with a cover removed;

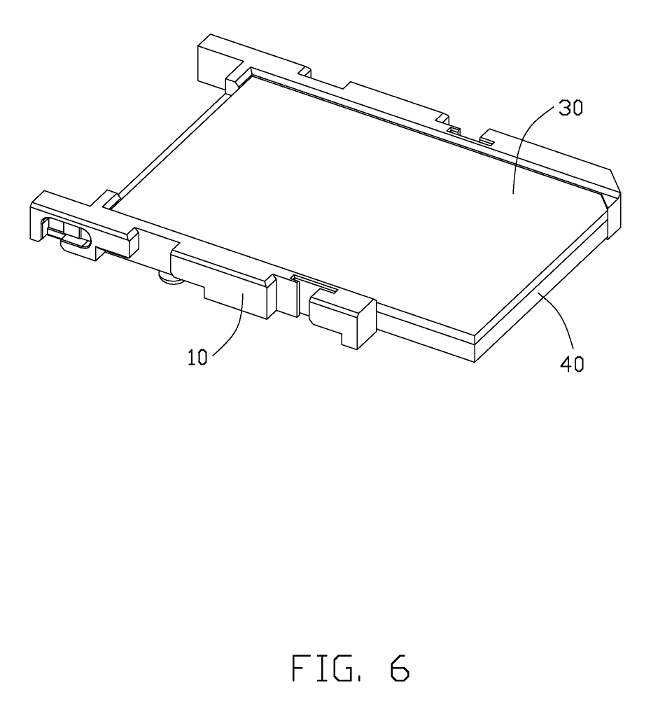

FIG. 7 is a bottom view of the electrical connector;

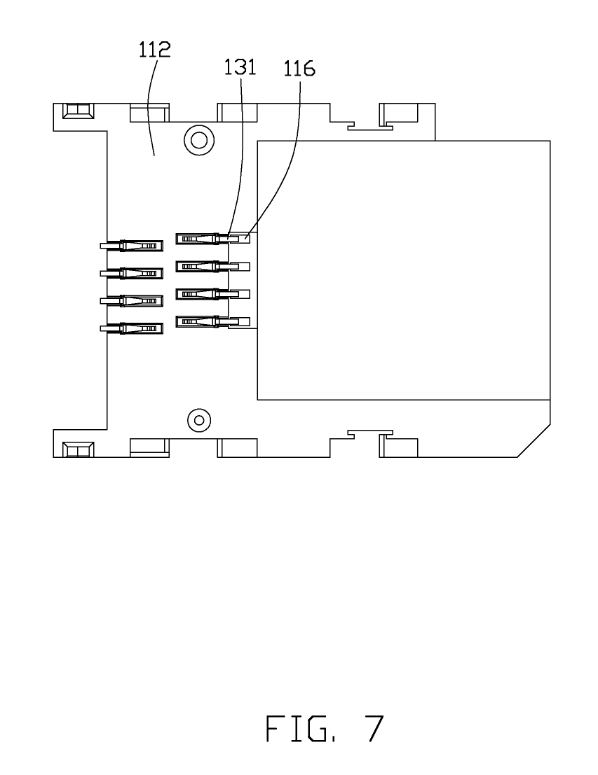

FIG. 8 is an enlarged perspective view of a portion of the electrical connector shown in FIG. 7; and

FIG. 9 is a perspective view of a conventional electrical connector.

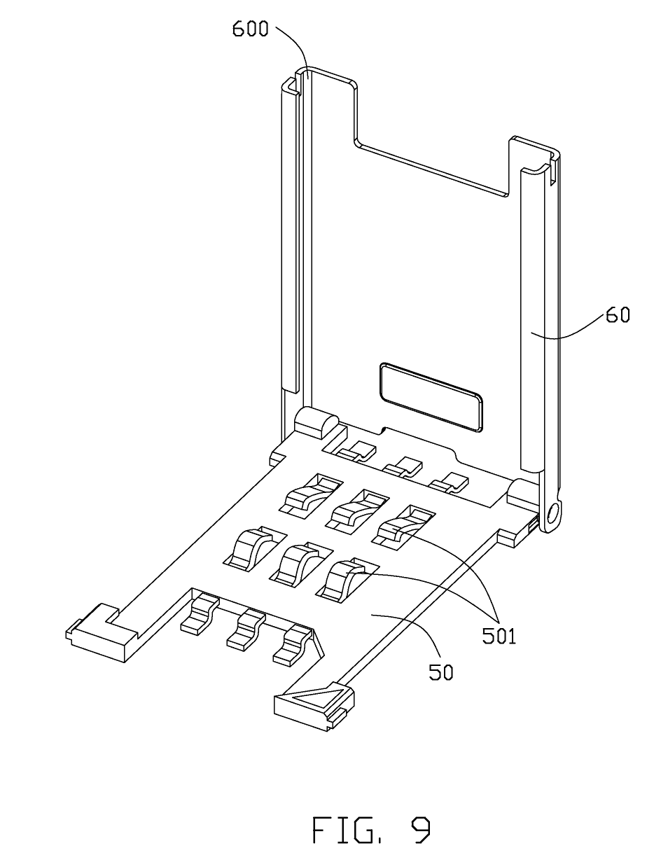

### DETAILED DESCRIPTION OF THE PREFERRED EMBODIMENT OF THE INVENTION

The present invention will now be described in detail with reference to a preferred embodiment thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps have not been described in detail in order to not unnecessarily obscure the present invention.

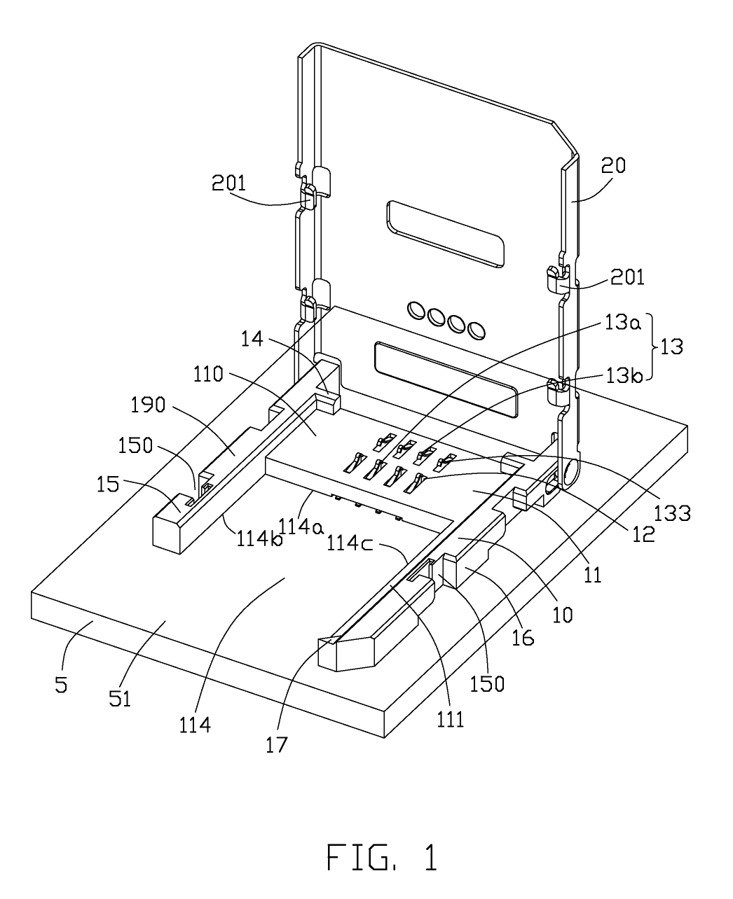

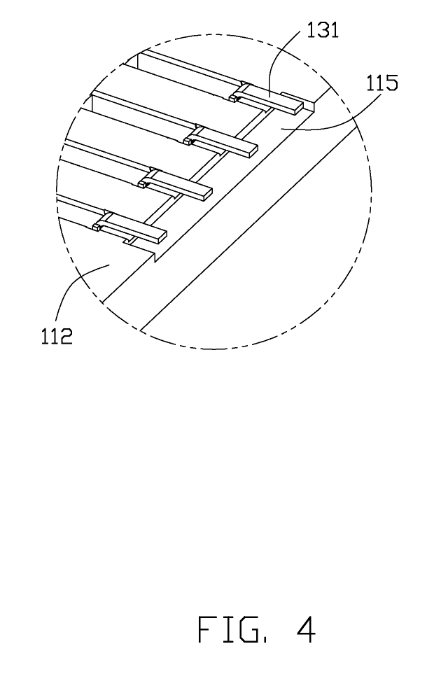

Referring to FIGS. 1 to 4, an embodiment of an electrical connector assembly according to certain teachings of the present disclosure is illustrated. The electrical connector assembly comprises a printed circuit board (PCB) 5 defining an upper surface 51, an electrical connector supported on the upper surface 51 and an optoelectronic module received in the connector. The connector includes an insulative housing 10, a cover 3 loaded on the insulative housing 10 and a plurality of terminals 6 secured in the housing 10.

The insulative housing 10 is seated upon the upper surface 51 of the PCB 5. The housing 10 defines a base 11 with opposite front and rear end regions along a front-to-back direction thereof and a plurality of side walls upwardly extending from the base 11. The base 11 cooperates with the side walls to commonly define a first receiving room 111. A notch defined in the front region of the base forms a second receiving room 114 under the first receiving room 111. The second receiving room 114 is smaller than the first receiving room 111 in both the front-to-back direction and a transverse direction perpendicular to said front-to-back direction.

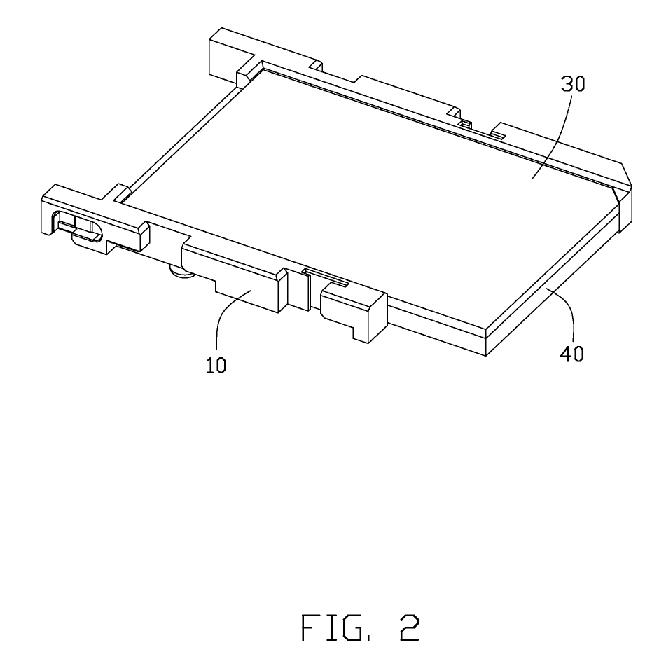

The optoelectronic module has stacked upper portion 30 and lower portion 40 as shown in FIG. 2. Said upper portion 30 is received in the upper receiving room 111 and said lower portion 40 is received in the lower receiving room 114.

A plurality of contacts 13 is disposed in passageways 12 of the rear region of said housing 10 and arranged in two rows. Each of the contacts 13 includes a contacting section 133 and a soldering tail 131. Said contacting sections 133 of the contacts 13 extend upwardly beyond an upward mating face 110 of the base 11 and into the first receiving room 111 so as to electrically connect with the upper portion 30 of the module. Said soldering tails 131 of the contacts 13 are located under the rear region of the base 11 and do not reach the first cutting edge 114a. In other words, the soldering tails 131 do not extend into the second receiving room 114 so as to prevent the soldering tails 131 from being electrically in contact with the lower portion 40 of the optoelectronic module. Therefore, an improper electrical connection is avoided.

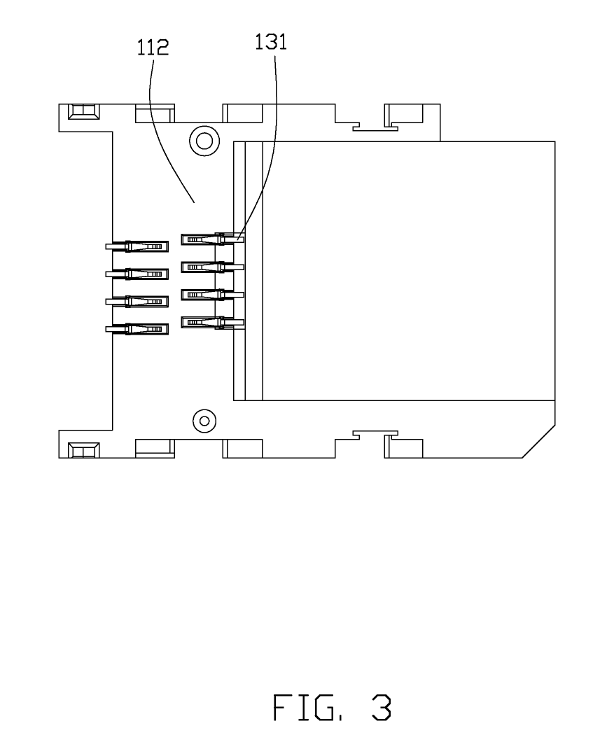

As shown in FIG. 3, the base 11 of said housing 10 defines a mounting face 112 opposite to the upward mating face 111, and a recess 115 is formed in the mounting face 112 and communicates with the second receiving room 114 for positioning the soldering tails 131.

The peripheral walls include opposite first side wall 15 and second side wall 16, a front wall 17 connecting with two ends of the two side walls and a rear wall 14 opposite to the front wall and connecting with the other ends of the two side walls, the four sidewalls have a common plane top surface which is higher than the plane top surface 110 of the base 11. The second side wall 16 extends forwardly longer than the opposite side wall 15, said front wall 17 extends upwardly from the supporting surface and connects with the end of the corresponding side wall. The front wall 17 is adapted to prevent the optoelectronic module from escaping from the insulative housing 10.

The cover 20 is pivotally mounted to the rear region of the base 11. The cover 20 integrally comprises four latch portions 201 adapted for mating with corresponding latch grooves 201 formed in the peripheral walls of the housing 10 so as to restrain the optoelectronic module from upward movement.

The notch defines a first cutting edge 114a proximate to the rear wall 14, and opposite second and third cutting edges 114b, 114c connecting with two ends of the first cutting edge 114a respectively. The third cutting edge 114c is spaced with a distance from the fourth wall 16 so as to provide a supporting surface 117 coplanar to the upper surface 110 of the base 11.

A first row of contacts 13a is arranged in a direction perpendicular to the front-to-back direction and proximate to the first cutting edge 114a. The contacting sections 133 of the contacts 13a extend rearward, and the soldering tails 131 of the contacts 13a extend forwardly into the recess 115 and do not reach the first cutting edge 114a. A second row of contact 13b is arranged parallel to the first row of contacts and far away from the first cutting edge 114a. The contacting sections 133 of the contacts 13b extend forwardly, and the soldering tails 131 of the contacts 13b extend rearward.

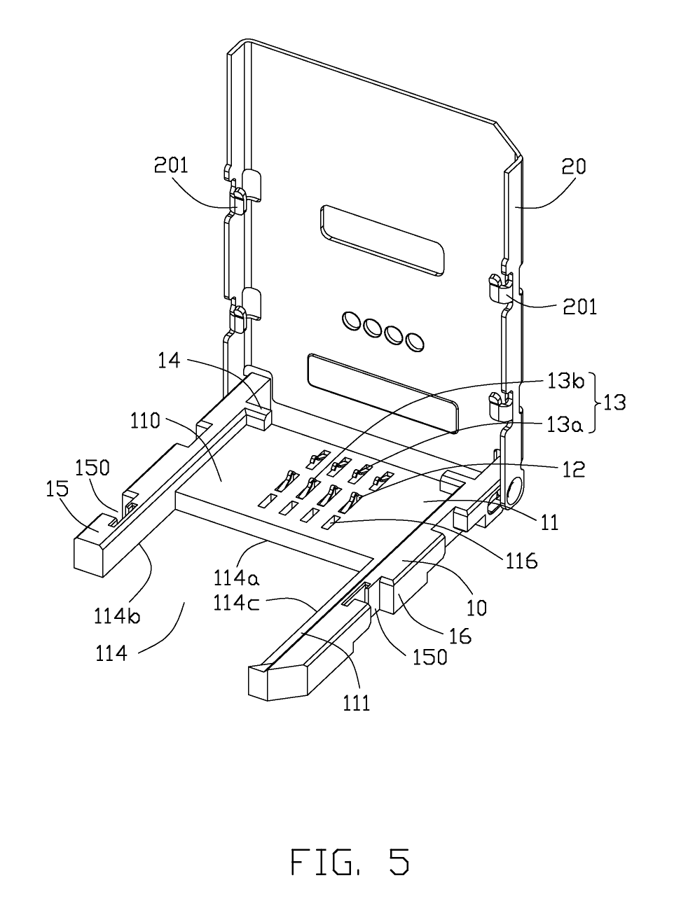

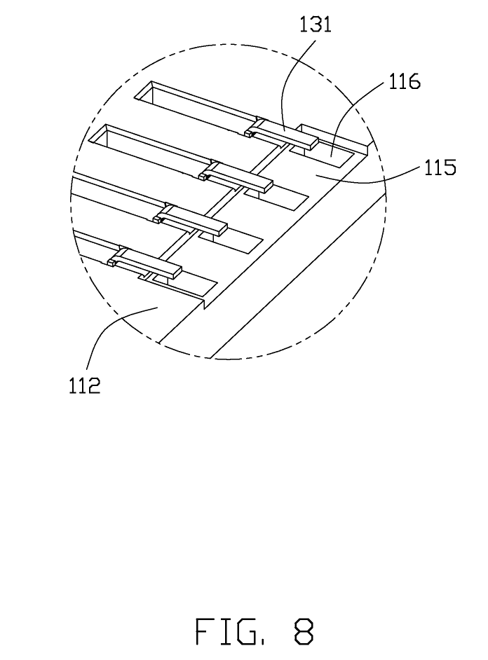

Referring to FIGS. 5 and 8 showing a second embodiment, which is similar to the first embodiment except the base of the insulative housing therefore the description of the elements same to the second embodiment are omitted. The base 11 of the insulative housing 10 further defines a plurality of through holes 116 located between the passageways 12 and the first cutting edge 114a and corresponding to the soldering tails 131 of contacts 13a so as to observe the soldering process.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electrical connector assembly comprising:
a printed circuit board defining an upper surface;
an insulative housing seated upon the upper surface, said housing defining a base with opposite front and rear end regions along a front-to-back direction and a plurality of side walls upwardly extending from the base, the base cooperating with the sidewalls to commonly define a first receiving room;
a notch defined in the front region of the base to form a second receiving room under the first receiving room, said second receiving room being smaller than the first receiving room in both the front-to-back direction and a transverse direction perpendicular to said front-to-back direction;
a plurality of contacts disposed in the rear region of said housing with contacting sections extending upwardly beyond an upward mating face of the base and into the first receiving room; and
an optoelectronic module having stacked upper portion and lower portion, said upper portion received in the upper receiving room and said lower portion received in the lower receiving room; wherein
soldering tails of said contacts are located under the rear region of the base and do not extend into the second receiving room so as to prevent the soldering tails from being electrically in contact with the lower portion of said optoelectronic module.

2. The electrical connector assembly as claimed in claim 1, wherein the base defines a mounting face opposite to the upward mating face, a recess is formed in the mounting face for positioning the soldering tails of the contacts.

3. The electrical connector assembly as claimed in claim 2, wherein the base further defines a plurality of through holes corresponding to the soldering tails of contacts for observation.

4. The electrical connector assembly as claimed in claim 7, wherein a cover is pivotally mounted to the rear region of the base and restrains the optoelectronic module from upward movement.

5. The electrical connector assembly as claimed in claim 1, wherein said peripheral walls include opposite first and second side walls, a front wall connecting with two ends of the two side walls and a rear wall opposite to the front wall and connecting with the other ends of the two side walls, the second sidewalls have a common plane top surface which is higher than the plane top surface of the base.

6. The electrical connector assembly as claimed in claim 5, wherein the notch defines a first cutting edge proximate to the rear wall, and opposite second and third cutting edges connecting with two ends of the first cutting edge respectively, the third cutting edge is spaced with a distance from the second wall so as to provide a supporting surface coplanar to the upper surface of the base.

7. The electrical connector assembly as claimed in claim 6, wherein the fourth side wall extends forwardly longer than the opposite side wall, said front wall extends upwardly from the supporting surface and connects with the end of the corresponding side wall.

8. An electrical connector comprising:
an insulative housing defining a base with opposite front and rear end regions along a front-to-back direction and a plurality of side walls upwardly extending from the base, the base cooperating with the sidewalls to commonly define a first receiving room;
a notch defined in the front region of the base to form a second receiving room under the first receiving room, thereby the base defining a first cutting edge facing forwards; and
a plurality of contacts disposed in the rear region of said housing, the contact comprising contacting sections extending upwardly beyond an upward mating face of the base and into the first receiving room and soldering tails located in a mounting face opposite to the upward mating face; wherein
at least one row of the soldering tails extend toward the second receiving room but not in the second receiving room.

9. The electrical connector as claimed in claim 8, wherein a cover is pivotally assembled to the housing, and restrains the optoelectronic module from upward movement.

10. The electrical connector as claimed in claim 8, wherein the notch defines second and third cutting edges connecting with two ends of the first cutting edge respectively, the soldering tails of said contacts do not reach the first cutting edge.

11. The electrical connector as claimed in claim 8, wherein a recess is formed in the mounting face of the housing and communicates with the second receiving room for positioning the soldering tails of said contacts.

12. The electrical connector as claimed in claim 11, wherein the housing defines a plurality of through holes located between the passageways and the first cutting edge and corresponding to the soldering tails of contacts for observation.

13. An electrical connector for use between an electronic package and a printed circuit board, comprising:
an insulative housing having a main body portion defining a transverse direction and front-to-back direction perpendicular to said transverse direction;
an upper receiving room formed above a mating face of the main body portion, and a lower receiving room formed in front of a front edge of the main body portion for commonly receiving said electronic package;
a plurality of contacts disposed in the housing and arranged in front and rear rows along the transverse direction so as to form a plurality of pairs each including two corresponding contacts being symmetrical with each other in said front-to-back direction; and
each of said pair of contacts including a resilient contacting section extending upwardly above a mating face of the main body portion, and a horizontal tail section extending away from the other contact in said front-to-back direction for soldering to said printed circuit board; wherein
the tail sections of the contacts in the rear row extend rearwardly beyond a rear edge of the main body portion for observation of soldering of the tail sections of the contacts n the rear row while tail sections of the contacts in a front row extend forward not beyond the front edge for protection consideration under condition that the main body portion, around said front edge, defines at least one recess set which extends at least either rearwardly or downwardly for the observation of soldering of the tail sections of the contacts in the front row.

14. The electrical connector as claimed in claim 13, wherein said recess set extends rearwardly from a lower region of the front edge, and essentially spans in the transverse direction to enclose the tail sections of all the contacts in the front row.

15. The electrical connector as claimed in claim 13, wherein said recess set extends downwardly from the mating face through the main body portion, and essentially defines a plurality of through holes corresponding to the contacts, respectively.
